(19) United States
(12) Patent Application Publication
(10) Pub. No.: US 2007/0126600 A1
(43) Pub. Date: Jun. 7, 2007

(54) Warning tube

(76) Inventor: Sunny En Liung Huang, Claremont, CA (US)

Correspondence Address: Paul M. Denk;Suite 170, 763 S. New Ballas Road, St. Louis, MO, 63141, US

(21) Appl. No.: 11/607,842

(22) Filed: Dec. 4, 2006

Related U.S. Application Data
(60) Provisional application No. 60/741,980, filed on Dec. 2, 2005.

(51) Int. Cl. G08G 1/095

(52) U.S. Cl. 340/908

(57) ABSTRACT

The warning tube guides drivers around an obstacle such as a construction site. Beginning with a base that has a neck, the warning tube has corrugations like an accordion, a sleeve at the lower end, its own neck at the upper end, and a variety of fittings temporarily placed into the neck. The fittings include a cap, a reflector, a light, and a traffic sign like a yield sign, among other things. After the sleeve is placed upon the neck of the base, the tube is expanded upward to position a fitting visible to drivers. The corrugations of the tube are bent at an angle to indicate the direction of the road ahead of the warning tube.

### CROSS-REFERENCE TO RELATED APPLICATION

This is a non-provisional application which claims priority to the provisional application Ser. No. 60/741,980 filed Dec. 2, 2005 and commonly owned by the same inventor. The above noted application is incorporated herein by reference.

### BACKGROUND OF THE INVENTION

This warning tube relates to traffic control devices and more specifically to temporary and portable roadway markers. A unique aspect of the present invention is a semi-rigid collapsible tube that accepts a variety of traffic controls.

Transitioning from horse drawn equipment where drivers had longer time to react to traffic and road conditions to engine powered vehicles where drivers have less time for judging traffic and road conditions, traffic control devices have increased in use and drivers have become dependent upon them. Traffic control devices operate at fixed locations, primarily intersections as in stop lights, at changes in a road as in grade signs, and at temporary locations as in construction sites.

Construction sites arise when a portion of a road gets repaired due to age, damage, or other causes. Construction often disturbs the road surface and traffic must be detoured around the construction site. Markers are installed at the entrance to a construction site and along the site. The markers inform traffic of the site and guide the traffic around the site. The markers are generally high enough for an automobile driver to see them and they have reflective or even illuminated portions for use at night or during inclement weather. The markers are spaced around and along a site to create an apparent line to guide drivers along the site.

Eventually, construction projects finish along a road. Part of closing a construction site involves removing the markers. As the markers are made to withstand the elements and minor brushes by vehicles, the markers are generally collected for reuse. Recovered markers are then stacked or collapsed for storage until used again. Though a construction site has been described, markers also see use for guiding traffic around accidents and for closing a road due to weather. Markers are used by construction companies, police and fire departments, highway departments, and related entities.

### DESCRIPTION OF THE PRIOR ART

As engine powered vehicles have traveled roads for some decades, various markers and traffic control devices have been developed. The devices position a light, sign, or reflector for a driver to see while the devices themselves are constructed to allow for storage and reuse. For example, there is a form of contractible traffic guide, as shown in the Whims U.S. Pat. No. 1,250,064. This particular device is used on a road, and is held by a chain, through a spring, into its erected condition. Presumably, the spring holds the guide erect, but when the guide bends, the spring contracts, the chain becomes more flexible, and the guide collapses.

The patent to Shoemaker, Jr., U.S. Pat. No. 3,132,624, is upon a collapsible signal device. The sleeve assembly can be collapsed, as when not in use. While this is a collapsible signal device, its flexible sheet turned into a cone is a different structure from the present invention.

The patent to Andrew God, U.S. Pat. No. 3,847,784, shows a metal pipe with spaced flexible portions. This is one of those metal pipes, with flexible corrugated portions that allow for bending the pipe, when applied by a plumber. Thus, the pipe can be fitted to the condition of usage.

The patent to Glitz, et al, U.S. Pat. No. 5,230,296, is upon a retractable parking aid. This is an expandable device, made of polypropylene, likely of similar material as used in constructing the present invention, but it is used primarily as a parking aid. Apparently, when one parks into a garage, and encounters this device, one ceases further movement into the garage. Though not like the present invention, it does utilize a corrugated tube.

The patent to Bent, et al., U.S. Pat. No. 6,014,941, shows a traffic delineator. This device is used upon the highway to help direct and channel traffic, around construction sites, and the like. This particular device defines the use of a handle at the center of the cylinder which is not the present invention. The handle is further defined as sized so as to pass through a circular opening in the base of the device.

The patent to Kramer, Jr., U.S. Pat. No. 6,102,078, shows rubber tubing with axially spaced annularly corrugated flexible segments. This device includes rubber tubing of a specified length. The device then has included in its structure the positioning of an end length of a sleeve of uncured rubber over an end portion of a forming mandrel. The end sleeve is not the structure of the present invention.

The patent to Brown, et al., U.S. Pat. No. 6,182,600, defines a traffic channeling device. This device is a cone-shaped channeling member that can be expanded, or contracted, so as to reduce its size. In its expanded stage, it is vertically erect. But, it can be contracted into the lowest portion, for storage. The present invention is not structured as telescoping or nesting portions as in this particular patent.

Finally, the published application to Kuo, No. US2002/0073912A1, is also upon a traffic delineator. This device is a cylinder, which has reflective sheets provided at the upper end, grip holes proximate to its bottom end, and a series of holes for flags.

The present art overcomes the limitations of the prior art. That is, in the art of the present invention, a warning tube accepts a variety of signals upon the upper end and has corrugations that permit bending of the tube. Existing devices collapse in various ways but do not retain a bent shape and carry a traffic signal or fitting. However, using a corrugated tube in the present invention provides a new means to display traffic signs and markers along a road to drivers.

The present invention overcomes the difficulties of the prior art. The warning tube has components that collapse and disassemble for storage and for transport. The warning tube also bends to withstand brushes with vehicles and to retain the shape of the road ahead of the warning tube. For instance, a construction site that forces drivers to bear right may have the warning tube bent to the right for a visual cue to the turn ahead. Combined with other devices, the warning tube readily integrates into existing traffic control programs.

### SUMMARY OF THE INVENTION

The warning tube is a device that guides drivers around an obstacle such as a construction site. The warning tube has a base with a neck, a tube having corrugations and a sleeve at the lower end and an opposite neck at the upper end, and a variety of signals or fittings temporarily placed into the neck of the tube. The fittings include a cap over the neck, a reflector, a light, and a traffic sign like a yield sign, among other things. The upper neck has a reflective band so the tube can be used without any fitting in the neck. The tube is stored and transported collapsed as it occupies the least volume. After the sleeve is placed upon the neck of the base, the tube is expanded upward to position a fitting at a height visible to drivers. If desired, the tube is bent at an angle to indicate the anticipated direction of the road ahead of the warning tube. The corrugations attain the bend and retain the warning tube in the bent shape.

Preferably, the neck of the tube has a round cross section that accepts round fittings. Alternatively the neck of the tube has a polygonal section that receives complementarily shaped fittings. The polygonal section prevents inadvertent turning of a fitting. In an alternate embodiment, the warning tube has a corrugated cone shape with a light upon the base. In another alternate embodiment, the warning tube has its sleeve fit upon a flashlight which transmits light through the tube. The present invention has usage at construction sites, accidents, and like places where traffic must rerouted differently from the normal flow and direction.

The principle object of this invention is to provide a warning tube made as a corrugated or bellows like structure, capable of flexibly being bent or curved to different angles in order to furnish more observable display of a cautioning or other warning.

A further object of this invention is to provide a staple base, with a corrugated means extending upwardly therefrom, which may be painted a caution orange, or be illuminated, in order to furnish a warning to nearby observers.

Still another object of this invention is to provide a warning device with inherent flexibility that allows for it usage for thoroughly cautioning any nearby drivers, workers, walkers, or other personnel, of the existence of an emergency condition.

These and other objects may occur to those skilled in the art upon review of the summary of the invention as provided herein, and upon undertaking a study of the description of its preferred embodiment, in view of the drawings.

### BRIEF DESCRIPTION OF THE DRAWINGS

FIG. 1 shows the present invention when collapsed;

FIG. 2 shows the present invention when extended;

FIG. 3 shows an exploded view of the present invention;

FIG. 3A has a view of the cap;

FIG. 3B has a view of the light feature;

FIG. 3C has a view of the sign feature;

FIG. 3D has a view of the reflector feature;

FIG. 3E has a top view of the neck in a hexagonal shape;

FIG. 3F has a top view of the neck in a rounded corner rectangular shape;

FIG. 3G has a top view of the neck in an oval shape;

FIG. 4 describes the present invention extended and bent into a non-linear shape;

FIG. 5 describes an alternate embodiment of the tube of the present invention;

FIG. 6 illustrates a conically shaped alternate embodiment of the present invention; and,

FIG. 7 shows the tube of the present invention in cooperation with a flashlight.

The same reference numerals refer to the same parts throughout the various figures.

### DESCRIPTION OF THE PREFERRED EMBODIMENT

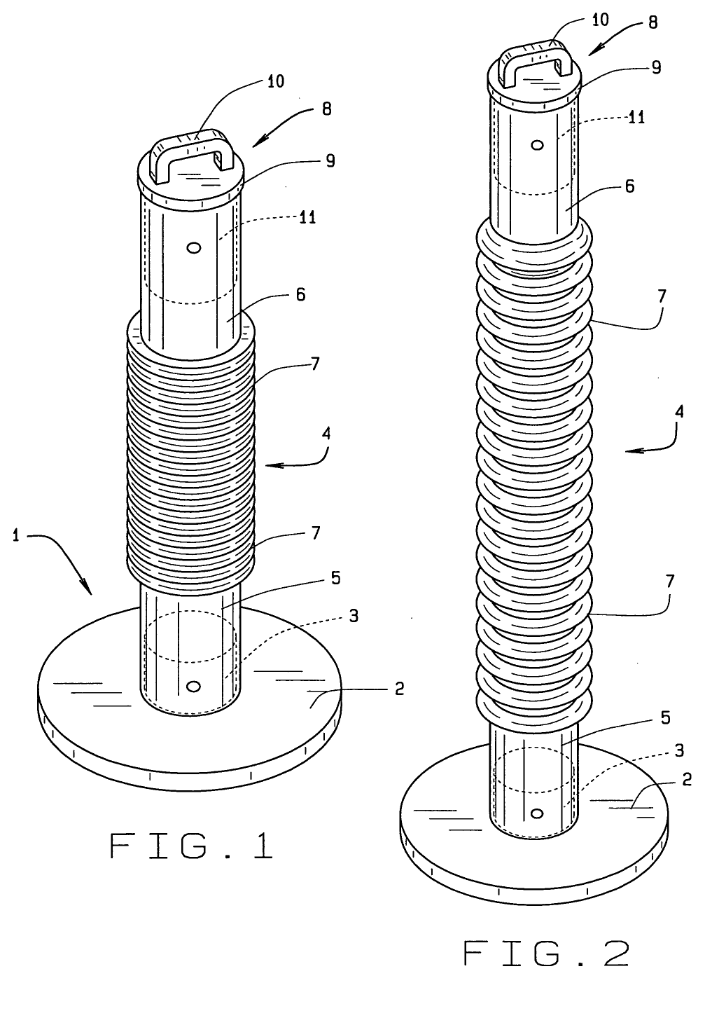

The present invention overcomes the prior art limitations by providing an extensible tube that bends into and retains a shape while carrying a traffic sign or directional indicator. Turning to FIG. 1, the warning tube of the present invention 1 begins with a base 2, here shown round. The base has a planar flat shape to reduce the incidence of tipping the present invention when in place to direct traffic. Generally centered upon the base, a neck 3, here shown in phantom, extends upwards from the base. The neck has a smaller width than the base and hollow cylindrical construction. Coaxial with the neck, a tube 4 extends upwards from the base. The tube has a sleeve 5 at one end and its own neck 6 at the opposite end. The sleeve has a diameter slightly larger than the neck 6 of the base but does fit snugly upon that neck. Above the sleeve, the tube has a series of mutually parallel and coaxial corrugations 7. The corrugations are accordion like and generally extend outside of the perimeter of the sleeve and the neck of the tube. The corrugations generally expand and extend the tube longitudinally. The tube has a plurality of corrugations provided so the tube reaches a certain height when extended, as later shown in FIG. 2. Above the corrugations, the tube has its own neck 6. This neck has the same diameter as the sleeve 5. This neck is generally hollow and admits the cap 8. The cap has a round lid 9 of greater diameter than this neck which allows the cap to rest upon the top of this neck. Upon the exterior surface of the lid, the cap has a handle 10 used to remove the cap for insertion of a traffic signal or fitting later described. Opposite the handle, the cap has a shank 11 depending beneath the lid. The shank has a diameter slightly less than this neck which allows for a snug fit of the cap into this neck. FIG. 1 shows the present invention in a collapsed state for storage and transport.

When the present invention is used, the tube is extended upwards or generally away from the base as shown in FIG. 2. As described previously, the present invention has a base with an upstanding neck. A sleeve fits the tube upon the neck and thus orients the tube upright. The tube is then pulled which opens the corrugations 7 and lengthens the tube 4. Within the neck of this tube, a cap 8 closes the tube.

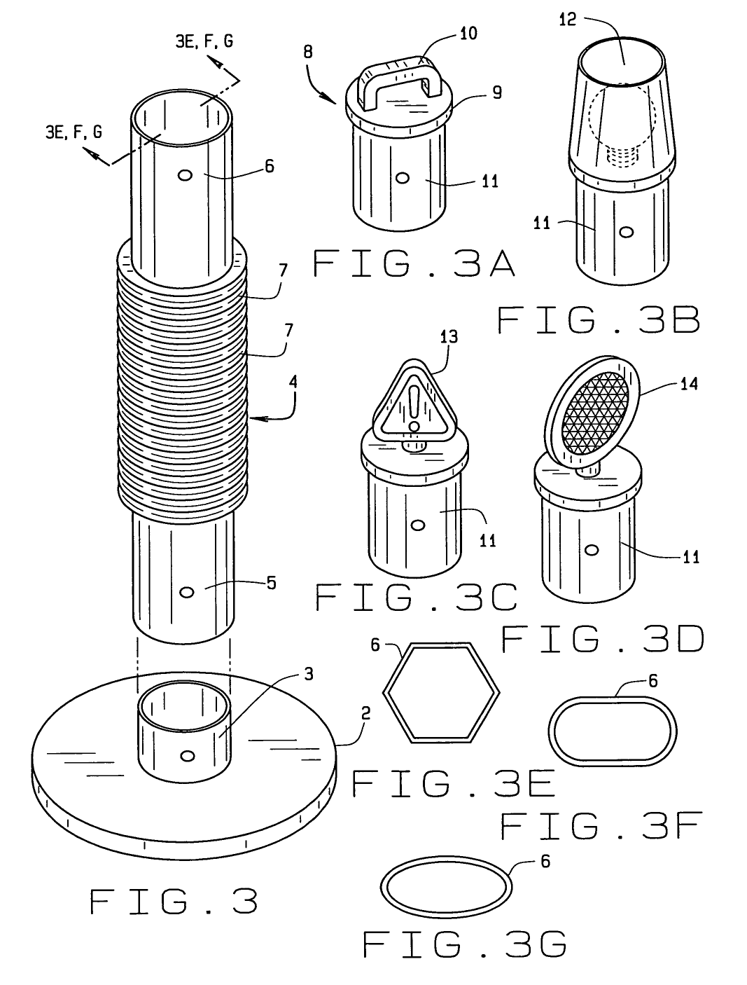

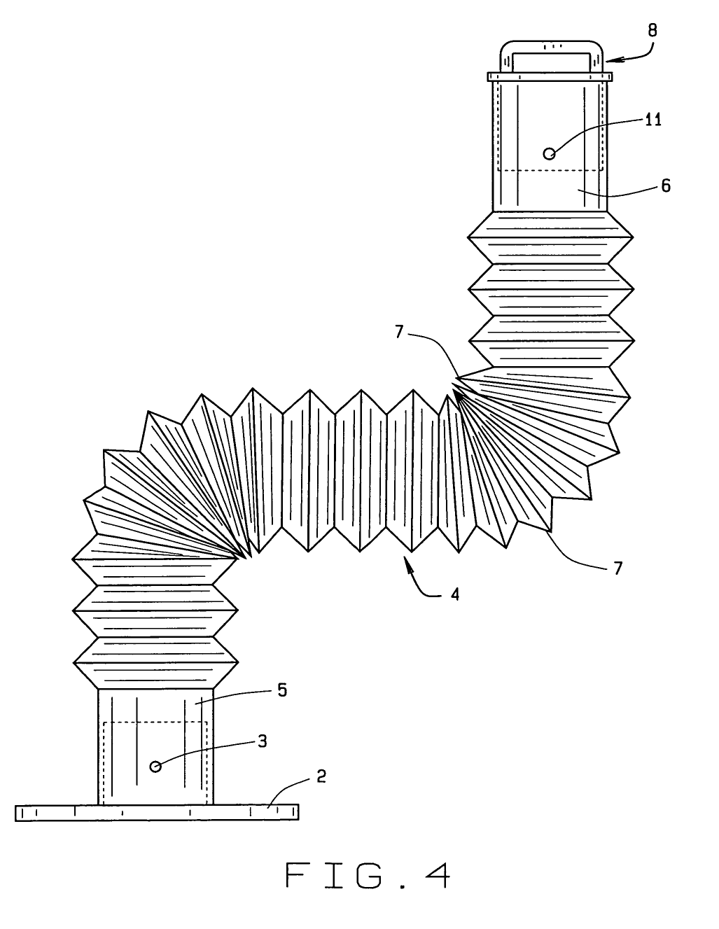

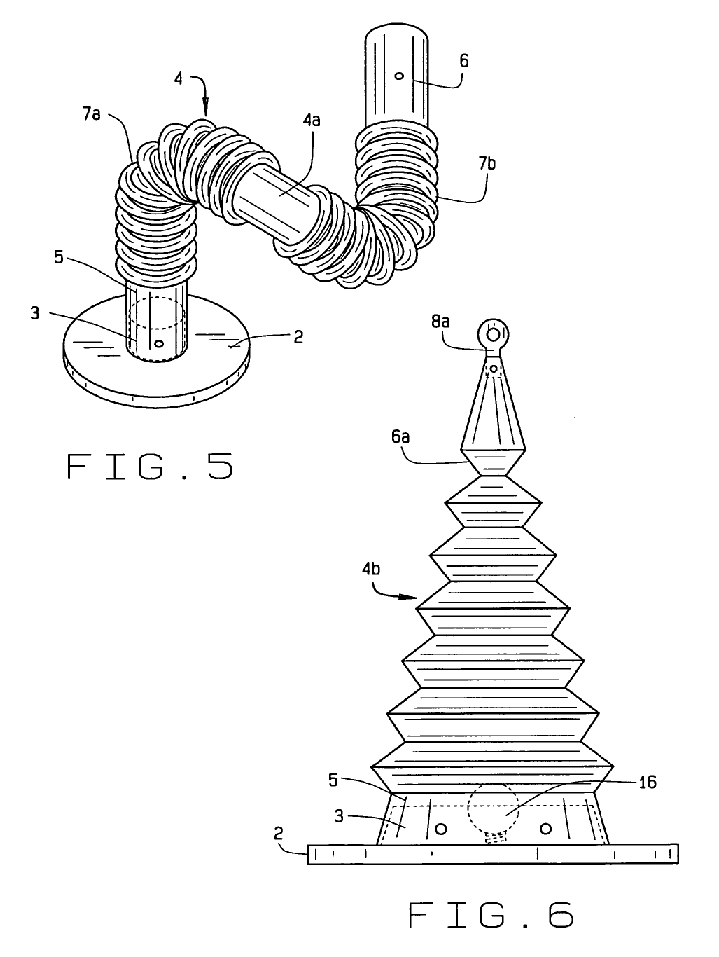

The present invention has additional features shown in FIG. 3. As a user desires a semi-permanent installation of the invention, the neck 3 of the base 2, the sleeve 5, the neck 6 of the tube 4, and the shank 11 of the cap 8 have cooperating threaded holes for a bolted connection. Using the holes, a user connects the tube 4 to the base 2, and the cap 8 or other traffic signal or fitting control to the neck 6 of the tube 4. The cap 8 has a generally cylindrical form with a hollow shank 11, a lid 9 upon one end of the shank, and a handle 10 upon a diameter of the lid opposite the shank as shown in FIG. 3A. Along with the cap, the present invention has additional traffic signals or fittings that fit within the neck 6 of the tube 4. A lighted traffic fitting 12 appears in FIG. 3B where a dome light is connected to the lid upon a shank. The light may illuminate constantly or intermittently as needed by the user. Besides the light fitting 12, a sign 13 to direct or to inform traffic can be placed upon the neck of the tube. The sign has an approved traffic control shape, color, and indicia generally perpendicular to the lid with a shank beneath shown in FIG. 3C. The sign here shown is the attention sign common in continental Europe but other traffic indicators are possible. Opposite the light, a reflector 14 can be placed upon the neck 6 of the tube 4, shown in FIG. 3D. Unlike the lighted traffic control which emits light, the reflector returns the light from vehicle headlights that falls upon the reflector in the direction of the vehicle. The reflector allows for illumination of a traffic control in the absence of battery or utility service to the present invention. The reflector attaches perpendicular to the lid and opposite the shank. The aforementioned traffic fittings generally have a threaded hole through the shank that allows bolting of the traffic fitting against inadvertent rotation in this neck 6.

Alternatively, the traffic controls may not rotate because of the shape of the neck. FIGS. 3E, 3F, and 3G show polygonal, rounded corner rectangular, and oval cross sections of the neck of this tube, respectively. These cross sections permit insertion of a complementarily shaped shank from a traffic control. As these cross sections have corners or asymmetric dimensions, a traffic fitting may not turn when placed into the neck of this tube.

Returning to the assembled present invention, FIG. 4 shows how the tube 4 bends into a desired shape. The corrugations expand upon one side and compress upon the opposite side to make a generally right angle bend. Generally the tube 4 bends in the direction of the compressed corrugations. The bends can mimic the shape of the road ahead of the warning tube. For example, FIG. 4 shows two bends in the tube which indicate the road ahead makes a right turn and then a left turn. As described previously, the present invention has a base with an upstanding neck over which a sleeve connects. The sleeve is the lower end of a tube having coaxial corrugations. The corrugations 7 are accordion like in that pulling the corrugations away from the base lengthen the tube as needed and permits the tube to bend. Opposite the sleeve, the tube has its own neck 6 into which a cap 8 or traffic fitting 12, 13, 14 inserts its shank 11.

Similar to FIG. 4, the tube of the present invention may have a straight portion 4a without corrugations as shown in FIG. 5. The straight portion adds to the length and rigidity of the tube. FIG. 5 shows a flat base with a sleeve 5 connected to the neck 3 of the base 2. The tube 4 then has a first portion 7a of corrugations coaxial with the tube generally near the sleeve and a then a straight section 4a midway up the tube. The straight section has no corrugations and does not bend. The straight section has a generally round shape with a diameter that of the inside diameter of a fold. The straight section generally has a length of at least one diameter. The tube continues with a second portion 7b of corrugations, opposite the first portion 7a, and ending in the neck 6 of the tube 4. Various traffic fittings and the cap can be placed in the neck as previously described.

The present invention may see use in many places and for many purposes. FIG. 6 shows an alternate embodiment of primarily the tube 4b. In this alternate embodiment, the warning tube has a conical shape 15 where the corrugations progressively decrease in diameter away from the base 2. The narrowest diameter 6a of the warning tube is opposite the base and has a ring shaped cap 8a. The base has a light 16 centered within the neck in this alternate embodiment. The light is generally battery powered however, solar power and utility power are alternate energy sources for the light. The tube 4a is generally translucent to make this alternate embodiment visible to drivers. The neck has a generally round shape of a diameter slightly less than the largest diameter of the conical warning tube.

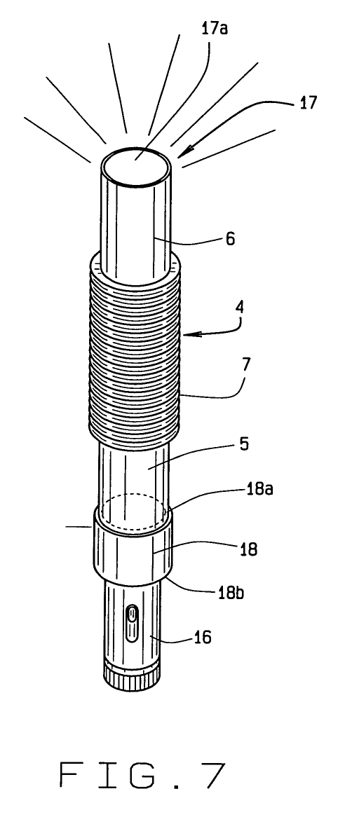

The tube of the present invention may also cooperate with other devices. FIG. 7 shows an alternate embodiment of the present invention in cooperation with a flashlight 16. In this alternate embodiment, the tube 4 begins with a sleeve 5. The sleeve is a hollow cylinder having a diameter compatible with a flashlight. The flashlight is generally handheld and powered by two D size batteries or equivalent. Above the sleeve, the tube has a plurality of coaxial corrugations 7 as previously described. The corrugations are also made of an opaque material however some light may leak at the outermost edge or ring where a corrugation flexes. Above the corrugations, the tube has a neck 6 of hollow cylindrical construction. Opposite the corrugations, the neck 6 has an opening 17 that emits light generated by the flashlight and transmitted through the tube. The opening may have a lens 17a as desired. The material for the sleeve and the neck has an opaque outer surface to prevent leakage of light from the tube and a reflective inner surface to direct light out of the tube. In this alternate embodiment, the sleeve connects to the rim of the flashlight sized to match the diameter of the sleeve. In a further alternate embodiment, the sleeve connects to one end 18a of an adapter 18. The opposite end 18b of the adapter has an aperture that fits the rim of a flashlight. Adapters are provided having one end sized for the sleeve and a plurality of opposite ends sized for different size and shape flashlight rims.

It should be understood that in the various corrugated or bellows like structures as provided herein, where they have a hollow segment interiorly, it is more than likely that any type of illuminating device, such as a light, may be included therein, with battery or other electrical connection, in order to furnish illumination either throughout the tube, at its upper end, as previously described, or at other locations where it may be desirable. For example, in the sleeve portion 5 of the tube, there may be a lamp and batteries provided therein, to illuminate that location, which may be either transparent, or tinted with an orange or florescent orange, or any other material that may transmit light. The light may extend upwardly and show through the coaxial corrugations 7, as can be understood. Or, such lighting may be included in the shank or neck portion 11, or at the neck 6, in order to furnish illumination therethrough. Or, as described in the application, the illumination may be at the upper signs 13, or reflectors 14, to furnish greater lighting and cautionary illumination therethrough. This is similar to what has been described in FIG. 3B.

From the aforementioned description, a warning tube has been described. The warning tube is uniquely capable of collapsing for storage and attaining a bent shape to indicate the road ahead of the present invention. The warning tube and its various components may be manufactured from many materials, including, but not limited to singly or in combination, polymers, polyester, polyethylene, polypropylene, polyvinyl chloride, nylon, ferrous and non-ferrous metals and their alloys, and composites.

Variations or modifications to the subject matter of this invention may occur to those skilled in the art upon review of the invention as described herein. Such variations if within the spirit of this development, is intended to be encompassed within the scope of the invention as described. The depiction of the invention in the drawings, and its description in the preferred embodiment, are set forth for illustrative purposes only.

I claim:

1. A device for controlling vehicular traffic comprising:
a base, generally planar in shape;
an extensible tube releasably connecting to said base having a plurality of coaxial accordion like corrugations; and,
at least one traffic control fitting releasably connecting to said tube opposite said base.

2. The traffic controlling device of claim 1 further comprising:
said base having a generally centered upright neck, said neck having a generally round hollow cylindrical construction.

3. The traffic controlling device of claim 1 further comprising:
said extensible tube having a sleeve, generally hollow and locating beneath said corrugations, and a neck, generally hollow, locating above said corrugations and opposite said base.

4. The traffic controlling device of claim 3 wherein said neck has the shape of one of round, polygonal, rectangular, or oval.

5. The traffic controlling device of claim 3 wherein said sleeve has the shape of one of round, polygonal, rectangular, or oval.

6. The traffic controlling device of claim 3 further comprising:
said at least one traffic control fitting having a planar lid and a shank depending from said lid, said shank inserting into said neck of said tube; and,
including one of a handle upon said lid opposite said shank, a light upon said lid opposite said shank, a traffic control sign upon said lid opposite said shank, or a reflector upon said lid opposite said shank.

7. The traffic controlling device of claim 2 further comprising:
said extensible tube having a sleeve upon one end beneath said corrugations and a neck opposite said sleeve, said neck having a narrower width than said sleeve; and,
said base having a light within said neck of said base.

8. A device for controlling vehicular traffic adapted to attach to a flashlight comprising:
an extensible tube releasably adapted to connect to said flashlight, having a sleeve, a plurality of coaxial accordion like corrugations above said sleeve, and a neck above said corrugations, said neck having an opening to transmit light from said flashlight out of said tube.

9. The vehicular traffic controlling device of claim 8 further comprising:
an adapter connecting said tube and a flashlight, and having two opposite ends.

10. The vehicular traffic controlling device of claim 8 further comprising:
said neck including a lens upon said opening.
